(19) United States
(12) Patent Application Publication
(10) Pub. No.: US 2015/0009996 A1
(43) Pub. Date: Jan. 8, 2015

(54) INFORMATION PROCESSING DEVICE AND INFORMATION PROCESSING SYSTEM

(71) Applicant: KABUSHIKI KAISHA TOSHIBA, Tokyo (JP)

(72) Inventors: Hideyuki Nakagawa, Tokyo (JP); Tadahiro Aihara, Tokyo (JP)

(73) Assignee: KABUSHIKI KAISHA TOSHIBA, Tokyo (JP)

(21) Appl. No.: 14/174,756

(22) Filed: Feb. 6, 2014

Related U.S. Application Data
(63) Continuation of application No. PCT/JP2013/068248, filed on Jul. 3, 2013.

(51) Int. Cl. H04L 12/741; H04N 5/44

(52) U.S. Cl. CPC H04L 45/74; H04N 5/44
USPC 370/392

(57) ABSTRACT

An information processing system includes a host module and a plurality of function modules. The host module includes an interface selector, an interface information notification module, an interface information confirmer and a communication control information storage. The interface selector is configured to select one of the plurality of function modules. The interface information notification module is configured to notify interface information of the selected one function module to at least the one function module which the interface selector has selected. The interface information confirmer is configured to receive a first identifier of the selected one function module from the one function module which the interface selector has selected. The communication control information storage is configured to store the first identifier associated with the interface information. Each of the plurality of function modules includes an interface information obtainer and an interface information response module.

### CROSS REFERENCE TO RELATED APPLICATIONS

This application is based upon and claims the benefit of priority from the prior PCT Patent Application No. PCT/JP2013/68248, filed on Jul. 3, 2013, the entire contents of which are incorporated herein by reference.

### FIELD

Embodiments described herein relate generally to an information processing device and an information processing system.

### BACKGROUND

In a video display system, more than one function modules might be connected to the host module, so as to add functions to the host module. In such a case, the host module needs to associate the interface information about the respective function modules with the identifiers of the respective function modules so that the host module can appropriately control each one of the function modules.

### BRIEF DESCRIPTION OF THE DRAWINGS

FIG. 1 is a block diagram schematically showing the structure of a video display system according to an embodiment.

FIG. 2 is a diagram schematically showing the structure of an Ethernet frame to be transmitted between the host module 1 and the function modules 21 through 23.

FIG. 3 is a diagram for explaining the command name and the action shown in FIG. 2.

FIG. 4 is a flowchart showing an example of a processing operation to be performed by the host module 1.

FIG. 5 is a diagram schematically showing the structure of the Ethernet frame transmitted in step S2.

FIG. 6 is a diagram schematically showing the Ethernet frame received in step S3.

FIG. 7 is a flowchart showing an example of a processing operation to be performed by the function modules 21 through 23.

FIG. 8 is a sequence diagram showing examples of processing operations to be performed by the host module 1 and the function modules 21 through 23.

FIG. 9 is a diagram schematically showing information about the function modules 21 through 23 stored in the communication control information storage 14.

FIG. 10 is a sequence diagram showing examples of processing operations to be performed by the host module 1 and the function module 22 in a case where IP addresses are obtained.

FIG. 11 is a diagram schematically showing the structure of the Ethernet frame transmitted in step S31.

FIG. 12 is a diagram schematically showing the structure of the Ethernet frame transmitted in step S23.

### DETAILED DESCRIPTION

According to an embodiment, an information processing system includes a host module and a plurality of function modules. The host module includes an interface selector, an interface information notification module, an interface information confirmer and a communication control information storage. The interface selector is configured to select one of the plurality of function modules. The interface information notification module is configured to notify interface information of the selected one function module to at least the one function module which the interface selector has selected. The interface information confirmer is configured to receive a first identifier of the selected one function module from the one function module which the interface selector has selected. The communication control information storage is configured to store the first identifier associated with the interface information. Each of the plurality of function modules includes an interface information obtainer and an interface information response module. The interface information obtainer is configured to receive a notification of the interface information from the interface information notification module and confirm whether the function module is selected by the interface selector. The interface information response module is configured to, when the function module is selected, transmit the first identifier of the function module and the interface information to the host module.

Hereafter, embodiments will be described in detail with reference to the drawings.

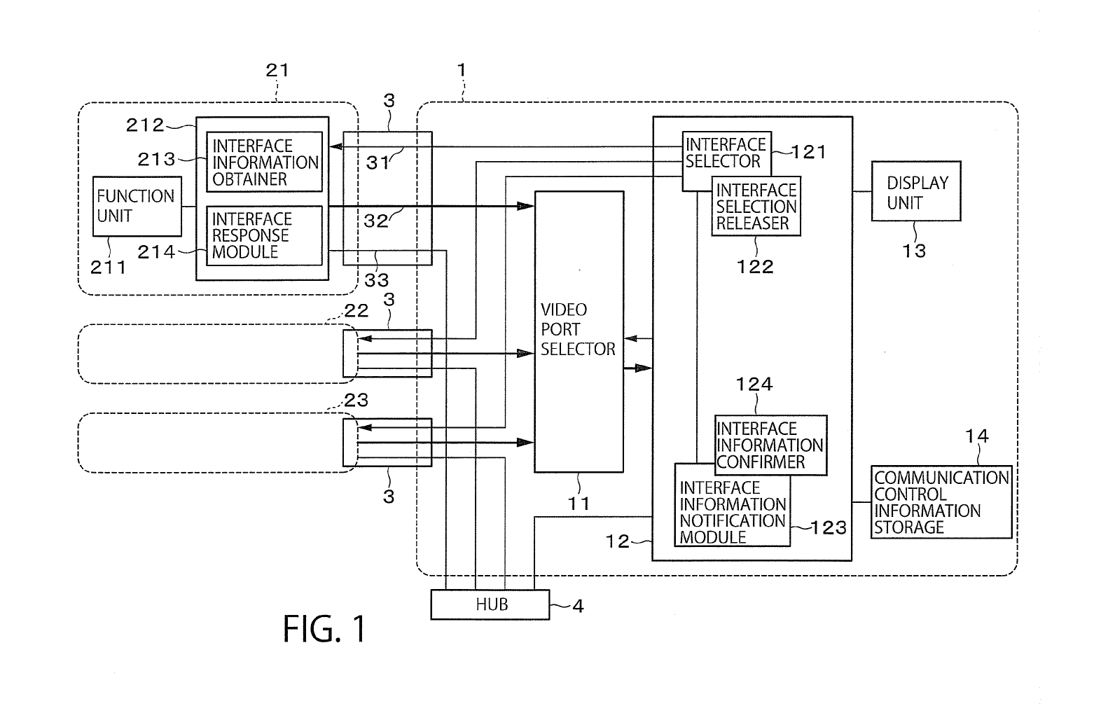

FIG. 1 is a block diagram schematically showing the structure of a video display system (an information processing system) according to an embodiment. The video display system includes a host module (an information processing device) 1 and function modules (information processing devices) 21 through 23. Although three function modules 21 through 23 are shown in the drawing, the number of function modules is not particularly limited.

Each of the function modules 21 through 23 is designed to add a function to the host module 1, and may be a tuner, for example. Video signals are supplied from the function modules to the host module 1 via common interfaces 3, and are displayed on a display unit 13 of the host module 1.

In a case where a video image from the function module 22 is displayed on the display unit 13, for example, the object to be operated by the user is the function module 22, not the function modules 21 and 23. To cause the function module 22 to reflect an operation by the user, the host module 1 needs to recognize the numbers of the function modules (hereinafter referred to as the interface numbers) associated with the identifiers (MAC addresses in this embodiment) of the function modules.

This embodiment is to realize this associating, and this aspect will be described below in detail.

The respective function modules 21 through 23 are detachably connected to the host module 1 by common interfaces 3. Each of the common interfaces 3 includes an interface select line 31, a video signal line 32, and an Ethernet (a registered trade name) line 33. One of the function modules 21 through 23 is selected by an interface select signal transmitted from the host module 1 via the interface select line 31. An operation to select a function module with an interface select signal is an operation to validate the interface select line connecting the host module 1 to one of the function modules by a voltage change or the like, but may be an operation to select one of the function modules by transmitting a signal containing a command from the host module 1 to the one of the function modules. Each video signal line 32 is an HDMI (High Definition Multimedia Interface), for example, and video signals are transmitted from the function modules 21 through 23 to the host module 1.

Each of the function modules 21 through 23 is also connected to a hub 4 via the Ethernet, and the hub 4 is connected to the host module 1 via the Ethernet. The hub 4 may be located outside the host module 1, or may be located inside the host module 1.

The host module 1 includes a video port selector 11, a system controller 12, the display unit 13, and a communication control information storage 14.

According to the control of the system controller 12, the video port selector 11 selects a video signal supplied from one of the function modules 21 through 23.

The system controller 12 includes an interface selector 121, an interface selection releaser 122, an interface information notification module 123, and an interface information confirmer 124.

The interface selector 121 selects one of the connected function modules 21 through 23 with an interface select signal via the corresponding interface select line 31.

The interface selection releaser 122 releases selection of a function module selected by an interface select signal.

When the interface selector 121 selects a function module, the interface information notification module 123 transmits an Ethernet broadcast frame to which the interface number (interface information) of the selected function module is added via the Ethernet line 33. The interface number is a number unique to the connected function module.

Upon receipt of the Ethernet frame from the function module via the Ethernet line 33, the interface information confirmer 124 obtains the originator MAC address and the interface number from the Ethernet frame. The interface information confirmer 124 then determines whether the obtained interface number is the same as the currently selected interface number (namely, the interface number of the function module currently selected by the interface selector 121).

The display unit 13 displays the video image corresponding to a video signal input from one of the function modules 21 through 23 via the video port selector 11.

When matching is confirmed by the interface information confirmer 124, the communication control information storage 14 stores the interface number associated with the originator MAC address. The communication control information storage 14 is realized by a ROM (Read Only Memory), a RAM (Random Access Memory), or the like.

Meanwhile, each of the function modules 21 through 23 includes a function unit 211 such as a tuner that outputs video signals, and a system controller 212. The system controller 212 includes an interface information obtainer 213 and an interface response module 214.

When receiving an Ethernet broadcast frame from the interface information notification module 123 of the host module 1 via the Ethernet line 33, the interface information obtainer 213 determines whether the function module of its own is selected by an interface select signal. If its own function module is selected, the interface information obtainer 213 obtains the MAC address and the interface number of the host module 1 which is the originator from the Ethernet broadcast frame.

The interface response module 214 transmits the Ethernet frame having the obtained interface number added thereto to the host module 1 via the Ethernet line 33, with the destination being the obtained MAC address of the host module 1.

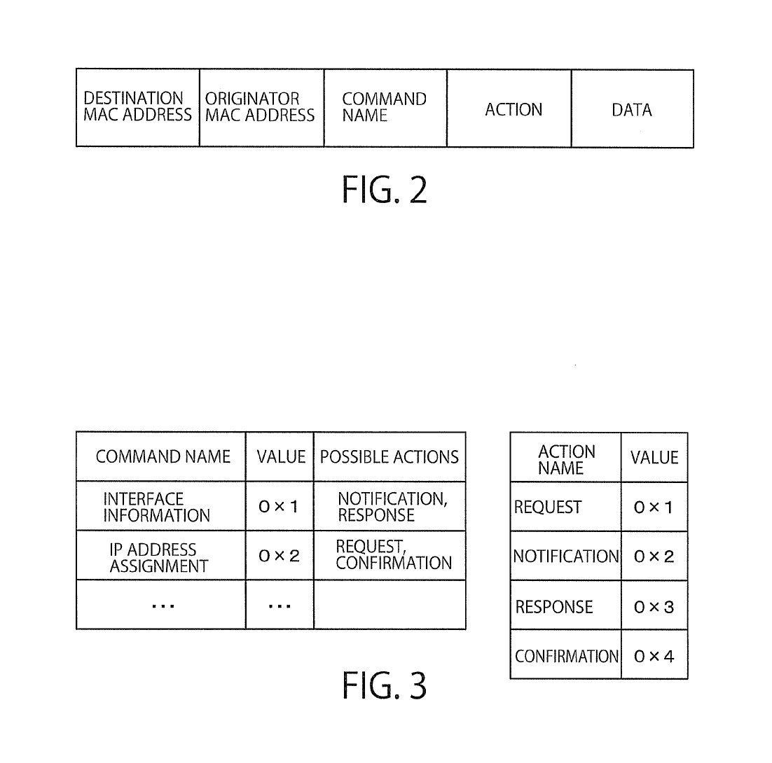

FIG. 2 is a diagram schematically showing the structure of an Ethernet frame to be transmitted between the host module 1 and the function modules 21 through 23. The Ethernet frame contains a destination MAC address, an originator MAC address, a command name, an action, and data. The Ethernet frame may further contain a preamble, an SFD, an FCS, and the like, but are not shown in the drawing.

The destination MAC address and the originator MAC address are the MAC addresses identifying the destination device and the originator device, respectively.

FIG. 3 is a diagram for explaining the command name and the action shown in FIG. 2. In a case where an interface number is to be associated with an MAC address, the command name is “interface information”. In this case, “0x1” is set in the command name. The action that can be taken at this case is “notification” or “response”. When the action is “notification”, “0x02” is set in the action. When the action is “response”, “0x03” is set in the action.

This video processing system may assign IP addresses, and in that case, the command name is “IP address assignment”. Here, “0x2” is set in the command name. The action that can be taken at this case is “request” or “confirmation”. When the action is “request”, “0x01” is set in the action. When the action is “confirmation”, “0x04” is set in the action.

A value in accordance with the command is set in the data shown in FIG. 2. For example, an interface number is set when the command name is “interface information”. When the command name is “IP address assignment”, an IP address is set. A value in accordance with a combination of a command and an action is set in the data shown in FIG. 2. For example, when the command name is “interface information”, an interface number is set. However, there are cases where the data shown in FIG. 2 does not contain any value. For example, when the command name is “IP address assignment” and the action is “request”, the data may not contain any value.

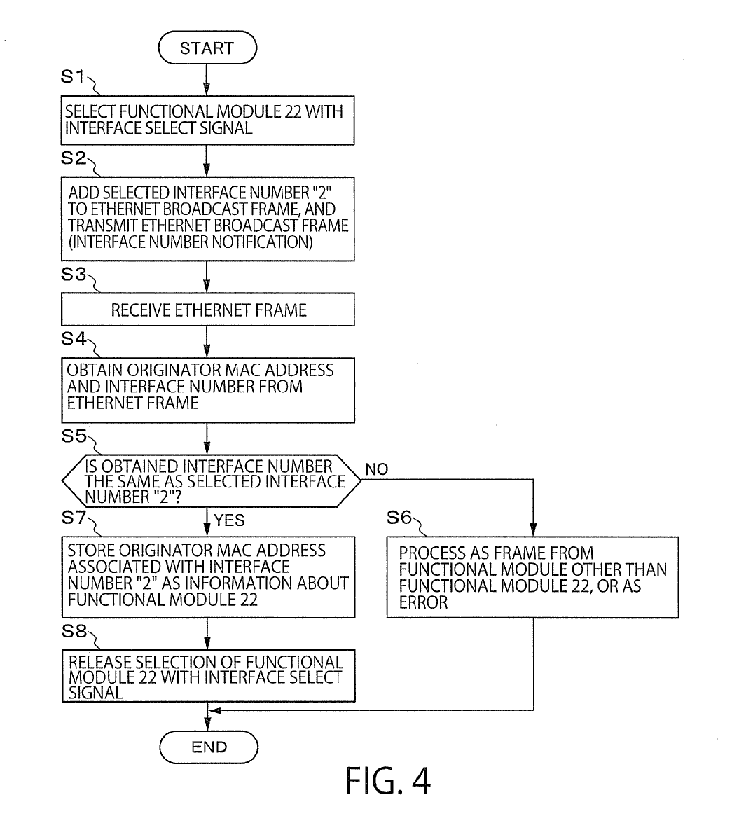

First, a processing operation to be performed by the host module 1 is described. FIG. 4 is a flowchart showing an example of a processing operation to be performed by the host module 1. This flowchart shows an example case where the host module 1 selects the function module 22, and associates an interface number with the MAC address of the function module 22.

First, the interface selector 121 transmits an interface select signal via the corresponding interface select line 31, to select the function module 22 (step S1).

The interface information notification module 123 then notifies the selected function module of the interface number. More specifically, the interface information notification module 123 adds the interface number “2” of the selected function module 22 to the Ethernet broadcast frame, and transmits this Ethernet broadcast frame to all the function modules 21 through 23 via the Ethernet lines 33 (step S2). In a case where the video display system is also Ethernet-connected to an external device (not shown) via the hub 4, the interface information notification module 123 preferably transmits the Ethernet broadcast frame only to the inside (namely, the function modules 21 through 23) of the video display system.

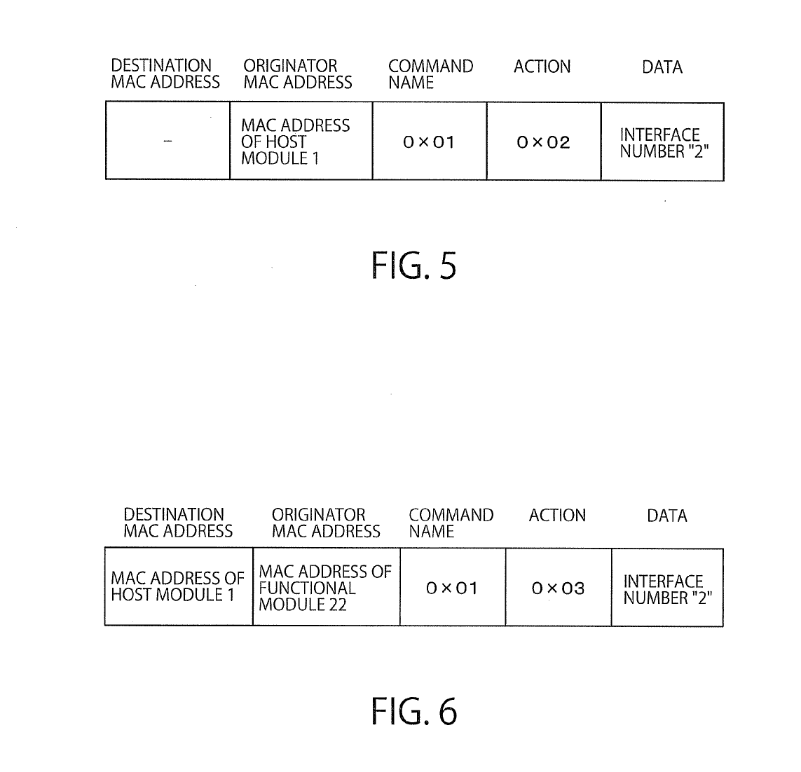

FIG. 5 is a diagram schematically showing the structure of the Ethernet frame transmitted in step S2. Since this Ethernet frame is transmitted in broadcast, 255.255.255.255 is designated in the designation MAC address. The MAC address of the host module 1 is set in the originator MAC address. Referring to FIG. 3, “0x01” (interface information) and “0x02” (notification) are set in the command name and the action, respectively. The interface number “2” is set in the data.

Referring back to FIG. 4, the host module 1 awaits reception of an Ethernet frame from the function module 22 (step S3).

FIG. 6 is a diagram schematically showing the Ethernet frame received in step S3. The MAC address of the host module 1 is set in the destination MAC address. The MAC address of the function module 22 as the originator is set in the originator MAC address. Referring to FIG. 3, “0x01” (interface information) and “0x03” (response) are set in the command name and the action, respectively. The interface number “2” is set in the data.

Referring back to FIG. 4, after the host module 1 receives the Ethernet frame, the interface information confirmer 124 obtains the MAC address of the function module 22 as the originator and the interface number from the Ethernet frame shown in FIG. 6 (step S4).

The interface information confirmer 124 further determines whether the obtained interface number is the same as the currently selected interface number “2” (step S5).

If the obtained interface number is not the same as the currently selected interface number (NO in step S5), the Ethernet frame is processed as an Ethernet frame from a function module other than the function module 22, or as an error (step S6).

If the obtained interface number is the same as the currently selected interface number (YES in step S5), the communication control information storage 14 associates the MAC address of the function module 22 as the originator with the interface number “2”, and stores the MAC address associated with the interface number “2” as the information about the function module 22 (step S7). The interface selection releaser 122 then releases the selection of the function module 22 with an interface select signal (step S8).

In the above described manner, the MAC address of the function module 22 can be associated with the corresponding interface number. This processing operation is sequentially performed for all the function modules 21 through 23, so that the association can be performed for all the function modules.

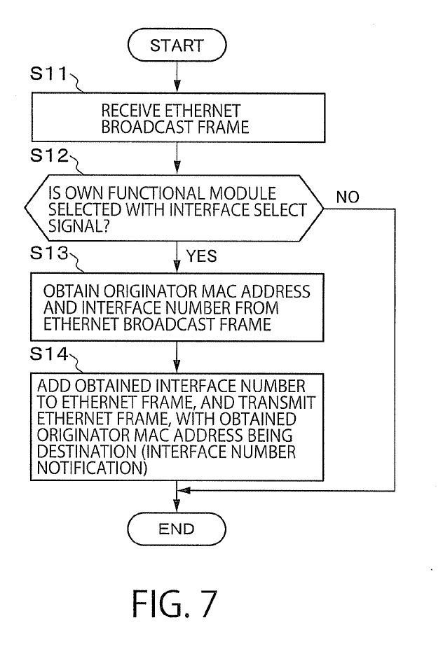

A processing operation to be performed by the function modules 21 through 23 is now described. FIG. 7 is a flowchart showing an example of a processing operation to be performed by the function modules 21 through 23.

The function modules 21 through 23 await reception of an Ethernet broadcast frame from the host module 1 (step S11). This Ethernet broadcast frame is transmitted by the host module 1 in step S2 in FIG. 2, and is shown in FIG. 5. As shown in FIG. 5, the Ethernet broadcast frame contains the MAC address of the host module 1 as the originator and one interface number.

Upon receipt of the Ethernet broadcast frame from the host module 1, the interface information obtainer 213 determines whether its own function module is selected by an interface select signal (step S12). Only when the function module is selected, the function module has the right to respond to this Ethernet broadcast frame.

If the function module is not selected (NO in step S12), the function modules 21 through 23 ignore the received Ethernet broadcast frame, and do not perform any particular processing.

If the function module is selected (YES in step S12), the interface information obtainer 213 obtains the MAC address of the host module 1 as the originator and the interface number from the Ethernet broadcast frame (step S13).

The function modules 21 through 23 then return the interface number. More specifically, the interface response module 214 adds the obtained interface number to the Ethernet frame, and transmits the Ethernet frame to the host module 1 via the Ethernet line 33, with the destination being the obtained MAC address of the host module 1 (step S14). The Ethernet frame transmitted here is shown in FIG. 6.

This Ethernet frame is processed by the host module 1 in step S3 and thereafter in FIG. 2.

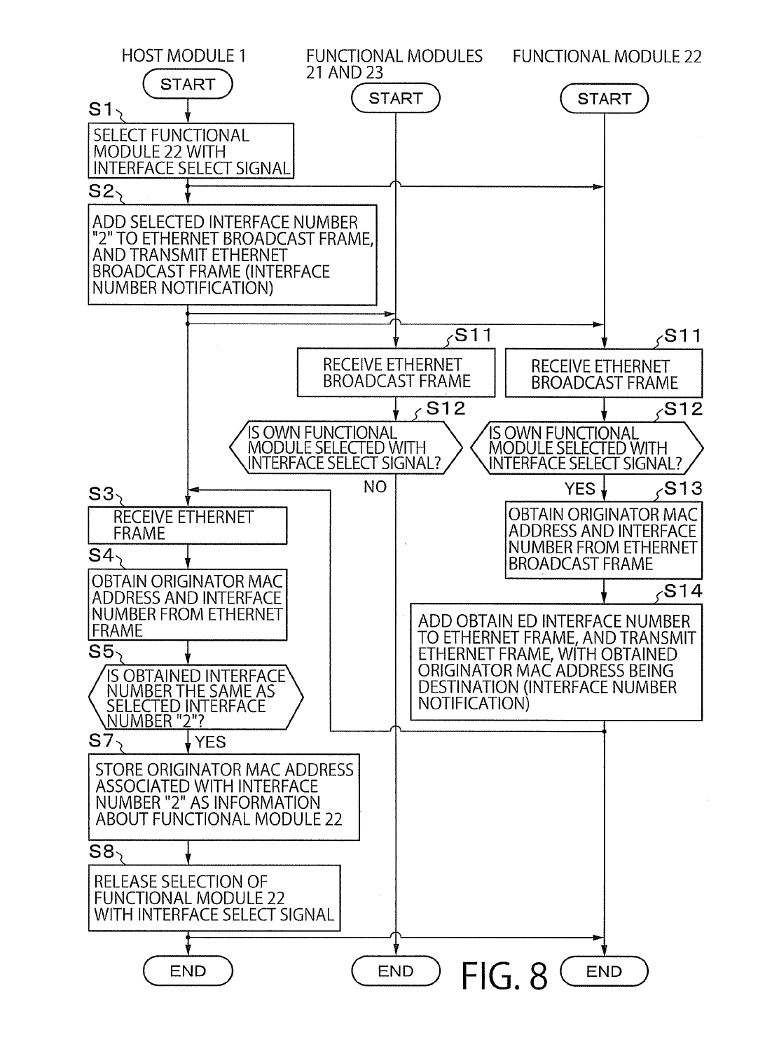

Next, operations to be performed by the host module 1 and the function modules 21 through 23 are relatedly described. FIG. 8 is a sequence diagram showing examples of processing operations to be performed by the host module 1 and the function modules 21 through 23. In this sequence diagram, the same reference numerals as those in FIGS. 4 and 7 are used. FIG. 8 shows an example case where the host module 1 selects the function module 22. Since the processing operation to be performed by the function module 21 is the same as that to be performed by the function module 23, those processing operations are collectively shown.

First, the interface selector 121 selects the function module 22 with an interface select signal via the interface select line 31 (step S1). The interface information notification module 123 then adds the interface number “2” of the selected function module 22 to an Ethernet broadcast frame, and transmits this Ethernet broadcast frame to all the function modules 21 through 23 via the Ethernet lines 33 (step S2).

The interface information obtainers 213 of the function modules 21 and 23 that have received the Ethernet broadcast frame (step S11) confirm that their own function modules are not selected by an interface select signal (NO in step S12). Accordingly, the function modules 21 and 23 ignore the received Ethernet broadcast frame.

Meanwhile, the interface information obtainer 213 of the function module 22 that has received the Ethernet broadcast frame (step S11) confirms that its own function module is selected by an interface select signal (YES in step S12). Accordingly, the interface information obtainer 213 obtains the MAC address of the host module 1 as the originator and the interface number from the Ethernet broadcast frame (step S13). With the obtained MAC address being the destination, the interface response module 214 adds the obtained interface number to the Ethernet frame, and transmits this Ethernet frame to the host module 1 via the Ethernet line 33 (step S14).

The host module 1 receives the Ethernet frame from the function module 22 (step S3). Thereafter, the host module 1 performs the above described procedures of steps S4 through S8.

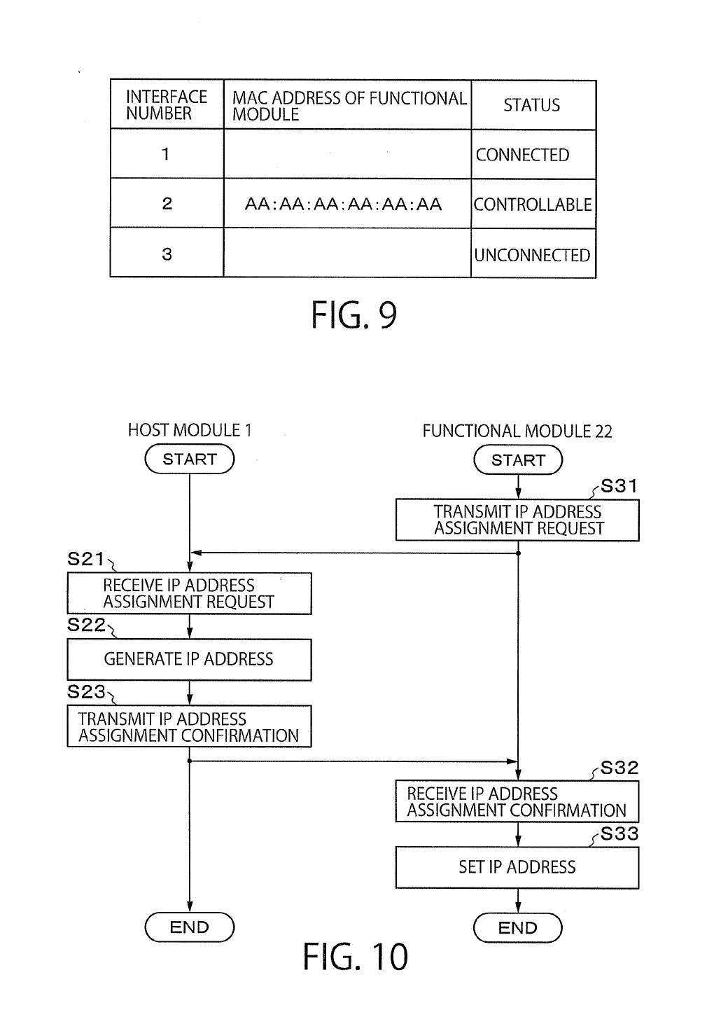

FIG. 9 is a diagram schematically showing information about the function modules 21 through 23 stored in the communication control information storage 14. The table shown in FIG. 9 is obtained by performing the above described processing sequentially for the respective function modules 21 through 23. As shown in FIG. 9, the communication control information storage 14 contains the interface numbers and the MAC addresses of the function modules 21 through 23 associated with each other, and may further contain status information.

The status of “unconnected” (a first state) indicates that the corresponding function module is not connected to the common interface 3. The status of “connected” (a second state) indicates that the corresponding function module is connected to the common interface 3, but the interface number and the MAC address have not been associated with each other, or the association has failed and communication control cannot be performed between the corresponding function module and the host. The status of “controllable” (a third state) indicates that the corresponding module is connected to the common interface 3, the interface number and the MAC address have been successfully associated with each other, and communication control can be performed between the corresponding function module and the host.

As well as the MAC addresses, IP addresses may be managed.

FIG. 10 is a sequence diagram showing examples of processing operations to be performed by the host module 1 and the function module 22 in a case where IP addresses are obtained. This sequence diagram shows an example case where the function module 22 requests IP address assignment to the host module 1.

First, the function module 22 transmits an IP address assignment request by an Ethernet frame to the host module 1 (step S31).

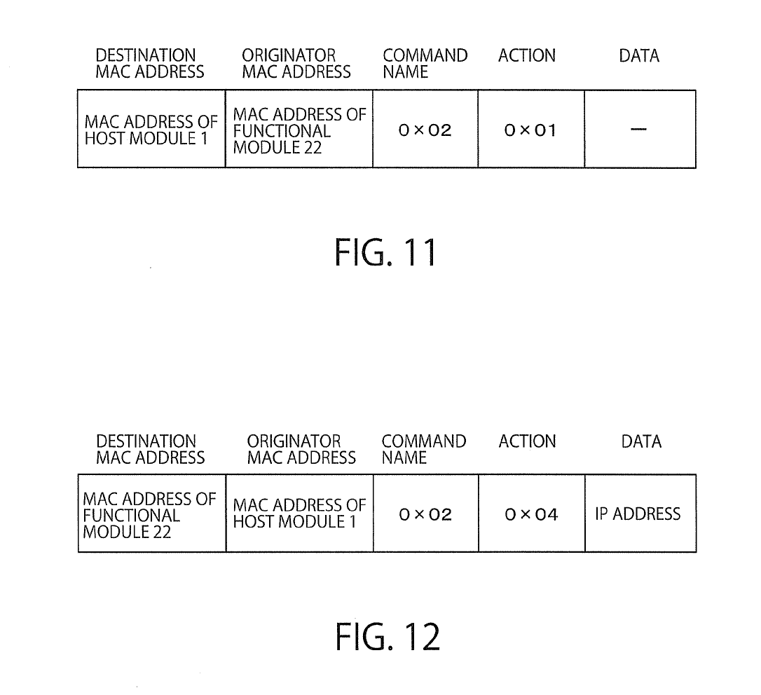

FIG. 11 is a diagram schematically showing the structure of the Ethernet frame transmitted in step S31. The MAC address of the host module 1 is set in the destination MAC address. The MAC address of the function module 22 is set in the originator MAC address. Referring to FIG. 3, “0x02” (IP address assignment) and

“0x01” (request) are set in the command name and the action, respectively. Any particular data is not set.

Referring back to FIG. 10, the host module 1 receives the IP address assignment request transmitted from the function module 22 (step S21). The host module 1 then determines that the originator is the function module 22 based on the originator MAC address, and generates the IP address associated with the interface number “2” (step S22). The IP address is preferably a value that is uniquely determined in accordance with the interface number. The host module 1 then transmits the generated IP address and an

IP address assignment confirmation by the Ethernet frame to the function module 22 (step S23). Here, the host module 1 does not need to transmit the IP address assignment confirmation to the other function modules 21 and 23.

FIG. 12 is a diagram schematically showing the structure of the Ethernet frame transmitted in step S23. The MAC address of the function module 22 is set in the destination MAC address. The MAC address of the host module 1 is set in the originator MAC address. Referring to FIG. 3, “0x02” (IP address assignment) and “0x04” (confirmation) are set in the command name and the action, respectively. The IP address is set in the data.

Referring back to FIG. 10, the function module 22 receives the IP address confirmation transmitted from the host module 1 (step S32). The function module 22 then sets the IP address assigned by the host module 1 (step S33).

Although not shown in FIG. 10, the function modules 21 and 23 can issue an IP address assignment request to the host module 1 at any time. The IP address that is assigned in this manner may be associated with the interface number and/or the MAC address, and be stored into the communication control information storage 14.

As described above, in this embodiment, the host module 1 can associate the interface information about each of the function modules 21 through 23 with the MAC address (a first identifier) and the IP address (a second identifier) serving as identifiers of the function module.

At least a part of the video processing system explained in the above embodiments can be formed of hardware or software. When the video processing system is partially formed of the software, it is possible to store a program implementing at least a partial function of the image processing device in a recording medium such as a flexible disc, CD-ROM, etc. and to execute the program by making a computer read the program. The recording medium is not limited to a removable medium such as a magnetic disk, optical disk, etc., and can be a fixed-type recording medium such as a hard disk device, memory, etc.

Further, a program realizing at least a partial function of the video processing system can be distributed through a communication line (including radio communication) such as the Internet etc. Furthermore, the program which is encrypted, modulated, or compressed can be distributed through a wired line or a radio link such as the Internet etc. or through the recording medium storing the program.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

1. An information processing system comprising:
a host module; and
a plurality of function modules,
wherein the host module comprises:
an interface selector configured to select one of the plurality of function modules;
an interface information notification module configured to notify interface information of the selected one function module to at least the one function module which the interface selector has selected;
an interface information confirmer configured to receive a first identifier of the selected one function module from the one function module which the interface selector has selected; and
a communication control information storage configured to store the first identifier associated with the interface information,
wherein each of the plurality of function modules comprises:
an interface information obtainer configured to receive a notification of the interface information from the interface information notification module and confirm whether the function module is selected by the interface selector; and
an interface information response module configured to, when the function module is selected, transmit the first identifier of the function module and the interface information to the host module.

2. The system of claim 1, wherein the host module is configured to connected with each of the plurality of function modules via an Ethernet line,
the interface information notification module is configured to transmit, to the interface information obtainer via the Ethernet line, a first Ethernet frame comprising the interface information of the one function module which the interface selector has selected, and
the interface information response module is configured to transmit, to the interface information confirmer, a second Ethernet frame comprising the first identifier of the function module and the obtained interface information.

3. The system of claim 2, wherein the first identifier is a MAC address.

4. The system of claim 2, wherein the interface information confirmer is configured to confirm whether the received second Ethernet frame is the second Ethernet frame from the one function module which the interface selector has selected, and
the communication control information storage is configured to store the first identifier associated with the interface information when the second Ethernet frame is confirmed as the second Ethernet frame from the selected one function module.

5. The system of claim 4, wherein the interface information confirmer is configured to confirm whether the received second Ethernet frame is the second Ethernet frame from the one function module which the interface selector has selected based on the interface information included in the received second Ethernet frame.

6. The system of claim 2, wherein the first Ethernet frame comprises information indicating that the first Ethernet frame is an Ethernet frame to notify the interface information to the function module, and
the second Ethernet frame comprises information indicating that second Ethernet frame is an Ethernet frame to respond the interface information to the function module.

7. The system of claim 1 further comprising an interface selection releaser configured to release a selection of the one function module which the interface selector has selected.

8. The system of claim 1, wherein the communication control information storage is configured to store a connection state of each of the plurality of function modules.

9. The system of claim 8, wherein each of the plurality of function modules are configured to connected detachably with the host module via a common interface,
wherein the connection state comprises:
a first state in which the function module is not connected to the common interface;
a second state in which the function module is connected to the common interface but the first identifier of the function module is not associated with the interface information; and
a third state in which the function module is connected to the common interface and the first identifier of the function module is associated with the interface information.

10. The system of claim 1, wherein each of the plurality of function modules is configured to transmit an identifier assign request to the host module, and
the host module is configured to generate a second identifier according to the identifier assign request and to transmit the generated second identifier to the function module which has transmitted the identifier assign request.

11. The system of claim 10, wherein the second identifier is an IP address.

12. An information processing device configured to communicate with a plurality of function modules, the information processing device comprising:
an interface selector configured to select one of the plurality of function modules;
an interface information notification module configured to notify interface information of the selected one function module to at least the one function module which the interface selector has selected;
an interface information confirmer configured to receive a first identifier of the selected one function module from the one function module which the interface selector has selected; and
a communication control information storage configured to store the first identifier associated with the interface information.

13. The device of claim 12, wherein the device is connected with each of the plurality of function modules via an Ethernet line, and
the interface information notification module is configured to transmit, to the interface information obtainer via the Ethernet line, a first Ethernet frame comprising the interface information of the one function module which the interface selector has selected.

14. The system of claim 13, wherein the first identifier is a MAC address.

15. An information processing device configured to communicate with a host module, the device comprising:
an interface information obtainer configured to receive a notification of interface information from the host module and confirm whether the information processing device is selected by the host module; and
an interface information response module configured to, when the information processing device is selected, transmit a first identifier of the information processing device and the interface information to the host module.
